(19) United States
(12) Patent Application Publication
(10) Pub. No.: US 2011/0004879 A1
(43) Pub. Date: Jan. 6, 2011

(54) METHOD AND APPARATUS FOR ELIMINATING WAIT FOR BOOT-UP

(75) Inventors: Thomas B. Olson, Allen, TX (US); Alan R. Ladd, The Colony, TX (US); Harshal S. Chhaya, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/496,470

(22) Filed: Jul. 1, 2009

(51) Int. Cl. G06F 9/46; G06F 15/177

(52) U.S. Cl. 718/102; 713/2

(57) ABSTRACT

A method and apparatus for eliminating wait for boot-up of an apparatus while simultaneously preventing increased power usage. The method includes predicting a boot-up schedule according to a determined usage schedule, and scheduling boot-up time according to the predicted boot-up schedule, wherein said boot-up schedule eliminates wait for boot-up while simultaneously preventing increased power usage.

### BACKGROUND OF THE INVENTION

1. Field of the Invention

Embodiments of the present invention generally relate to a method and apparatus for eliminating wait for boot-up while simultaneously preventing increased power usage.

2. Background of the Invention

It is a common goal in most electronics to attempt to reduce power usage. It is also a common goal for the electronics that require boot-up to attempt to reduce the time needed to reach boot-up a device. In device, such as, computers, laptops, phones and calculators, maintaining information in memory utilizes too much power. Thus, memory is cleared and reloaded at boot-up. However, this solution results in a longer boot-up time. In order to shorten boot-up time, more information is maintained in memory. However, this solution consumes too much energy/power.

Therefore, there is a need for an improved method and apparatus for reducing boot-up time while simultaneously preventing increased power usage.

### SUMMARY OF THE INVENTION

Embodiments of the present invention relate to a method and apparatus for eliminating wait for boot-up of an apparatus while simultaneously preventing increased power usage. The method includes predicting a boot-up schedule according to a determined usage schedule, and scheduling boot-up time according to the predicted boot-up schedule, wherein said boot-up schedule eliminates wait for boot-up while simultaneously preventing increased power usage.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. In this application, a computer readable processor is any medium accessible by a computer for saving, writing, archiving, executing and/or accessing data. Furthermore, the method described herein may be coupled to a processing unit, wherein said processing unit is capable of performing the method.

FIG. 1 is an embodiment of an apparatus for eliminating wait for boot-up while simultaneously preventing increased power usage;

FIG. 2 is a flow diagram depicting an embodiment of a method for eliminating wait for boot-up while simultaneously preventing increased power usage; and

FIG. 3 is an embodiment depicting a calculator for eliminating wait for boot-up while simultaneously preventing increased power usage.

### DETAILED DESCRIPTION

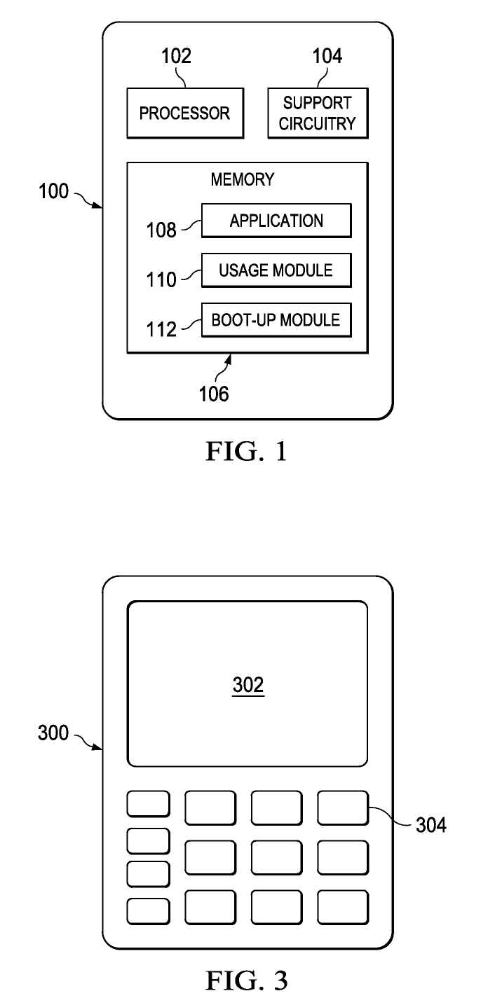

FIG. 1 is an embodiment of an apparatus 100 for eliminating wait for boot-up while simultaneously preventing increased power usage. The apparatus 100 includes a processor 102, support circuitry 104, and memory 106.

The processor 102 may comprise one or more conventionally available microprocessors. The microprocessor may be an application specific integrated circuit (ASIC). The support circuits 104 are well known circuits used to promote functionality of the processor 102. Such circuits include, but are not limited to, a cache, power supplies, clock circuits, input/output (I/O) circuits and the like. The memory 106 may comprise random access memory, read only memory, removable disk memory, flash memory, and various combinations of these types of memory. The memory 106 is sometimes referred to main memory and may, in part, be used as cache memory or buffer memory. The memory 106 may store an operating system (OS), database software, and various forms of application software, such as, applications 108, usage module 110, boot-up module 112 and the like.

The applications 108 are any applications that are stored or utilized by the apparatus 100. The usage module 110 tracks and analyzes user's usage habits. For example, the usage module 110 will determine if the student regularly utilizes the apparatus 100 on Mondays through Fridays at ten (10) in the morning. The usage module 110 makes such usage data readily available for the boot-up module 112.

The boot-up module 112 utilizes the usage data from the usage module 110 to boot-up the apparatus prior to the predicted usage. For example, the usage module 110 determines that the apparatus 100 is usually utilized Monday through Friday at ten (10) in the morning. The boot-up module 112 initiates a boot-up of the apparatus 100 prior to the predicted usage, for example, at nine fifty-five (9:55) in the morning. As a result, the apparatus 100 is capable of reducing power usage while eliminating wait for boot-up of the apparatus 100.

It should be noted, the usage module 110 and boot-up module 112 may be combined into the same module. Further more, the prediction of the boot-up time may be done by either the usage module 110 or the boot-up module 112.

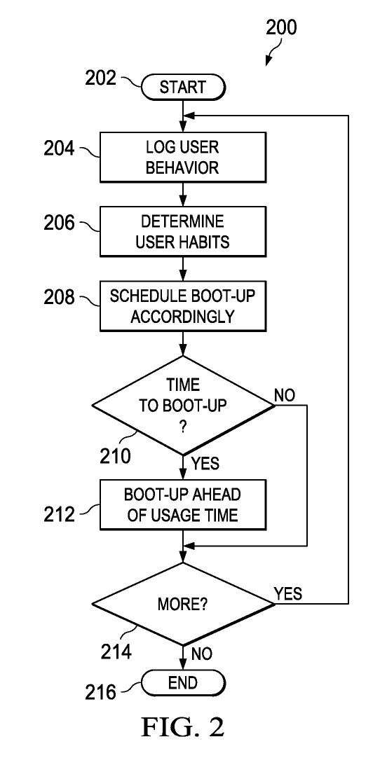

FIG. 2 is a flow diagram depicting an embodiment of a method 200 for eliminating wait for boot-up while simultaneously preventing increased power usage. The method 200 starts at step 202 and proceeds to step 204. At step 204, the method 200 logs the user's usage behavior. At step 206, the method 200 determines the user habits and predicts boot-up time and/or date. At step 208, the method 200 schedules a boot-up according to the predicted time and/or date. At step 210, the method 200 determines if it is time for boot-up. If it is time boot-up, the method 200 proceeds to step 212. At step 212, the method 200 boots-up the apparatus prior to the predicted usage time and the method 200 proceeds to step 214. If it is not boot-up time, the method 200 proceeds from step 210 to step 214. At step 214, the method 200 determines if there is more data to log or boot-ups. If either is true, the method 200 proceeds to step 204. Otherwise, the method 200 proceeds to step 216. The method 200 ends at step 216.

FIG. 3 is an embodiment depicting a calculator 300 for eliminating wait for boot-up while simultaneously preventing increased power usage. The calculator is a device that is utilized in a classroom, businesses, households, or the like for solving/computing mathematical or geometrical expressions and problems. A calculator and its unique usage are known and easily distinguished from various other electronic devices. The calculator 300 includes a display screen 302 and a key board 304. The display screen 302 presents inputs from the keyboard 304 and solutions calculated. The calculator 300 utilizes the method 200 described in FIG. 2. By utilizing the method 200, the calculator 300 is capable of predicting the usage time and/or date and boot-up prior to such predicted usage. For example, a student has algebra class every Monday, Wednesday and Friday at one (1) in the afternoon. The calculator will predicted such usage and initialize a boot-up whereas the calculator is boot-up and ready for usage at one (1) in the afternoon. Thus, the calculator may boot-up at twelve fifty eight (12:58) in the afternoon for preparation for the predicted usage.

While the foregoing is directed to embodiments of the present invention, other and further embodiments of the invention may be devised without departing from the basic scope thereof, and the scope thereof is determined by the claims that follow.

What is claimed is:

1. A method for eliminating wait for boot-up of an apparatus while simultaneously preventing increased power usage, the method comprising:
predicting a boot-up schedule according to a determined usage schedule; and
scheduling boot-up time according to the predicted boot-up schedule, wherein said boot-up schedule eliminates wait for boot-up while simultaneously preventing increased power usage.

2. The method of claim 1 further comprising logging usage of the apparatus.

3. The method of claim 1, wherein the determined schedule accounts for at least one of date, day and time.

4. The method of claim 1 further comprising booting-up the apparatus.

5. An apparatus for eliminating wait for boot-up of an apparatus while simultaneously preventing increased power usage, comprising:
means for predicting a boot-up schedule according to a determined usage schedule; and
means for scheduling boot-up time according to the predicted boot-up schedule, wherein said boot-up schedule eliminates wait for boot-up while simultaneously preventing increased power usage.

6. The apparatus of claim 5 further comprising means for logging usage of the apparatus.

7. The apparatus of claim 5, wherein the determined schedule accounts for at least one of date, day and time.

8. The apparatus of claim 5 further comprising means for booting-up the apparatus.

9. A computer readable medium comprising software that, when executed by a processor, causes the processor to perform a method for eliminating wait for boot-up of an apparatus, the method comprising:
predicting a boot-up schedule according to a determined usage schedule; and
scheduling boot-up time according to the predicted boot-up schedule, wherein said boot-up schedule eliminates wait for boot-up while simultaneously preventing increased power usage.

10. The computer readable medium of claim 9, wherein the method further comprises logging usage of the apparatus.

11. The computer readable medium of claim 9, wherein the determined schedule accounts for at least one of date, day and time.

12. The computer readable medium of claim 9, wherein the method further comprises booting-up the apparatus.
